(19) United States
(12) Patent Application Publication
(10) Pub. No.: US 2022/0116510 A1
(43) Pub. Date: Apr. 14, 2022

(54) IMAGE FORMING APPARATUS, IMAGE FORMING METHOD, AND RECORDING MEDIUM

(71) Applicant: Genki UMEIZUMI, Kanagawa (JP)

(72) Inventor: Genki UMEIZUMI, Kanagawa (JP)

(21) Appl. No.: 17/488,306

(22) Filed: Sep. 29, 2021

(30) Foreign Application Priority Data
Oct. 14, 2020 (JP) 2020-173570

(51) Int. Cl. H04N 1/23; G06K 15/02; G06F 3/12; H04N 1/00

(52) U.S. Cl. CPC H04N 1/233; G06K 15/1806; G06F 3/1205; H04N 1/00779; G06F 3/1257; H04N 1/00692; G06F 3/1258

(57) ABSTRACT

An image forming apparatus include a printing engine to form an image on a print medium and circuitry. The circuitry determines whether each page of print data is a blank page, determines whether a blank sheet is to be generated by printing of the print data in accordance with print settings, determines whether to remove a blank page from the print data to avoid generation of the blank sheet, generates changed print data based on whether to remove the blank page in accordance with the print settings, controls the printing engine to perform printing on the print medium according to the changed print data in accordance with the print settings, and counts a number of pages printed, excluding blank pages in the printed pages and the blank page which have been removed from the print data.

### CROSS-REFERENCE TO RELATED APPLICATION

This patent application is based on and claims priority pursuant to 35 U.S.C. § 119(a) to Japanese Patent Application No. 2020-173570, filed on Oct. 14, 2020, in the Japan Patent Office, the entire disclosure of which is hereby incorporated by reference herein.

### BACKGROUND

### Technical Field

Embodiments of the present disclosure relate to an image forming apparatus, an image forming method, and a recording medium.

### Related Art

Documents set in an image forming apparatus such as a multifunction peripheral (MFP) may include a blank page. There has been disclosed a technique for preventing an image forming apparatus from printing a blank page included in a document. Hereinafter, a function of fixedly or selectively setting whether to print a blank page is referred to as a blank page removal function.

Among image forming apparatuses having such a blank page removal function, there is known an image forming apparatus that does not remove a blank page intentionally mixed in a document even when the blank page removal function is enabled

### SUMMARY

An embodiment of the present disclosure provides an image forming apparatus that includes a printing engine to form an image on a print medium, and circuitry. The circuitry determines whether each page of print data is a blank page, determines whether a blank sheet is to be generated by printing of the print data in accordance with print settings, determines whether to remove a blank page from the print data to avoid generation of the blank sheet, and generates changed print data based on whether to remove the blank page in accordance with the print settings. The circuitry controls the printing engine to perform printing on the print medium according to the changed print data in accordance with the print settings, and count a number of pages printed and exclude, from the count, blank pages in the printed pages and the blank page which have been removed from the print data.

Another embodiment provides a method for forming an image. The method includes determining whether each page of print data is a blank page, determining whether a blank sheet is to be generated by printing of the print data in accordance with print settings, determining whether to remove a blank page from the print data to avoid generation of the blank sheet, generating changed print data based on whether to remove the blank page in accordance with the print settings, controlling a printing engine to perform printing on the print medium according to the changed print data in accordance with the print settings, and counting a number of pages printed, excluding blank pages in the printed pages and the blank page which have been removed from the print data.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating an example of a configuration of a system including a multifunction peripheral (MFP) according to one embodiment of the present disclosure;

FIG. 2 is a block diagram illustrating an example of a hardware configuration of the MFP illustrated in FIG. 1;

FIG. 3 is a block diagram illustrating an example of a software configuration of the MFP illustrated in FIG. 1;

FIG. 4 is a block diagram illustrating an example of a functional configuration of the system including the MFP illustrated in FIG. 1;

FIG. 5 is a view illustrating an example of a copy application screen;

FIG. 6 is a view illustrating examples of a blank page removal setting screen;

FIG. 7 is a diagram illustrating an operation for blank page removal for a single-sided document according to one embodiment;

FIG. 8 is a diagram illustrating an operation for blank page removal for a double-sided document according to one embodiment;

FIG. 9 is a diagram illustrating an operation for blank page removal in two-in-one combine printing according to one embodiment;

FIG. 10 is a diagram illustrating an operation for blank sheet removal for a single-sided document according to one embodiment;

FIG. 11 is a diagram illustrating an operation for blank sheet removal for a double-sided document according to one embodiment;

FIG. 12 is a diagram illustrating an operation for blank sheet removal in two-in-one combine printing according to one embodiment; and

FIG. 13 is a flowchart illustrating an example of a copying process performed by the MFP illustrated in FIGS. 1 to 4.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, descriptions are given of an image forming apparatus, an image forming method, and a recording medium storing program codes for the method according to embodiments of the present disclosure. The present disclosure, however, is not limited to the following one or more embodiments, and the elements of the following one or more embodiments include elements that may be easily conceived by those skilled in the art, those being substantially the same ones, and those being within equivalent ranges. Furthermore, various omissions, substitutions, changes and combinations of the constituent elements may be made without departing from the gist of the following one or more embodiments.

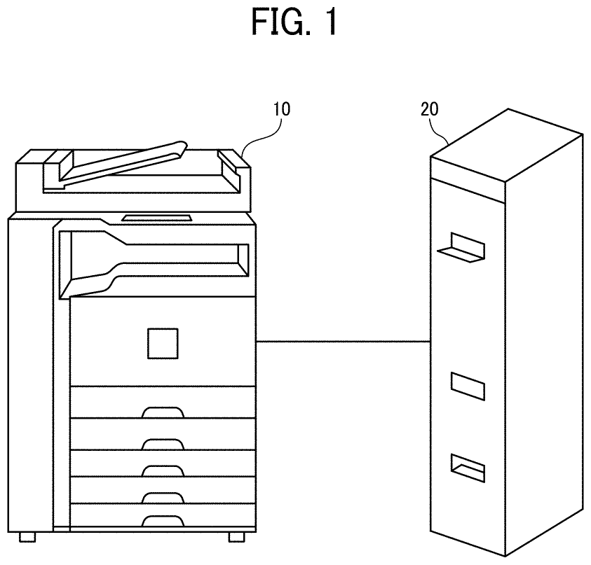

FIG. 1 is a diagram illustrating an example of a configuration of a system including a multifunction peripheral (MFP) according to the present embodiment. A description is given below of the configuration of the system including the MFP 10 according to the present embodiment with reference to FIG. 1.

FIG. 1 illustrates a system including an MFP 10 and a charging device 20. The MFP 10 is an image forming apparatus that reads, with a scanner, a document set on, for example, an automatic document feeder (ADF) and forms (prints) an image based on the read image. The term “MFP” used in this specification refers to a multifunction peripheral having at least two of a copy function, a printer function, a scanner function, and a facsimile function, for example.

The charging device 20 is a device for charging for printing or copying according to the number of prints or copies. The charging device 20 can be a known device that includes a cash slot for inserting money (bills or coins) and accepts payment according to the number of printed or copied sheets. The charging device 20 may further include a card reader or a card insertion slot to receive payment with cards such as electronic money cards or prepaid cards in addition to the cash slot. When a user inserts a bill, a coin, a prepaid card, or electronic money, the charging device 20 notifies the MFP 10 of the inserted amount (deposit amount).

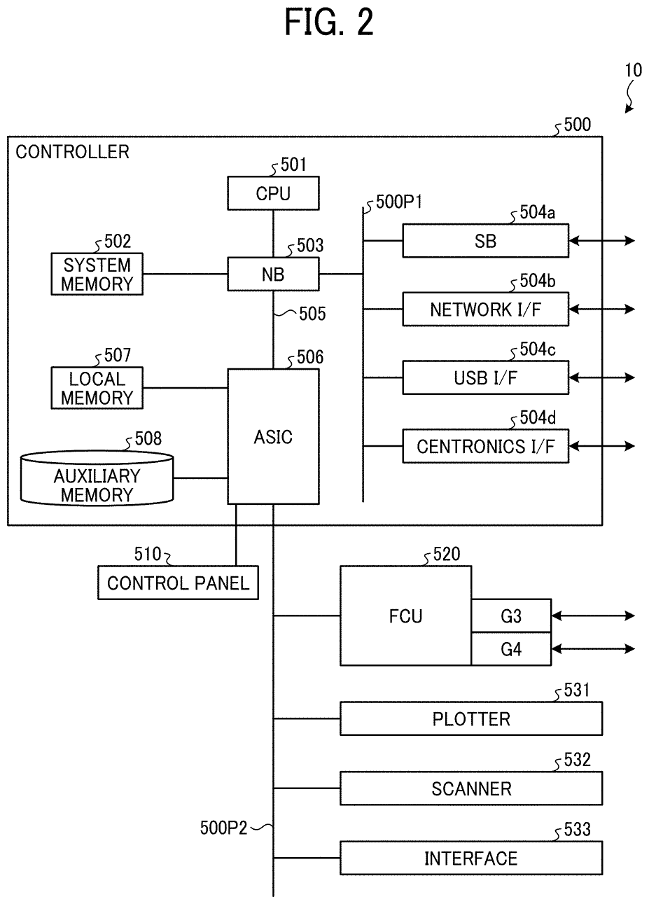

FIG. 2 is a block diagram illustrating an example of a hardware configuration of the MFP according to the present embodiment. A description is given below of the hardware configuration of the MFP 10 according to the present embodiment with reference to FIG. 2.

As illustrated in FIG. 2, the MFP 10 includes a controller 500, a control panel 510, a facsimile control unit (FCU) 520, a plotter 531, a scanner 532, and an interface 533 that are connected by a peripheral component interconnect (PCI) buses 500P1 and 500P2. The control panel 510 is an example of an input device and an example of a display. The plotter 531 is an example of a printing device.

The controller 500 is a device that controls the entire operation, drawing, and communication performed by the MFP 10 and controls input from the control panel 510.

The control panel 510 as the input device includes, for example, a touch panel and keys. The control panel 510 receives an input to the controller 500 (input function) and displays the status of the MFP 10 (display function). The control panel 510 is directly connected to an application-specific integrated circuit (ASIC) 506 described later.

The FCU 520 is a device that provides a facsimile function, and is connected to the ASIC 506 via, for example, a PCI bus 500P2.

The plotter 531 is a device that provides a printing function, and is connected to the ASIC 506 via, for example, the PCI bus 500P2. The scanner 532 is a device that provides a scanner function, and is connected to the ASIC 506 via, for example, the PCI bus 500P2.

The interface 533 is, for example, an interface for data communication with the charging device 20, and is connected to the ASIC 506. The charging device 20 may communicate with the controller 500 via a network interface (I/F) 504b or a universal serial bus (USB) I/F 504c, which will be described later, not limited to communication via the interface 533.

The controller 500 includes a central processing unit (CPU) 501, a system memory 502, a north bridge (NB) 503, a south bridge (SB) 504a, the network interface (I/F) 504b, the USB I/F 504c, a Centronics I/F 504d, the ASIC 506, a local memory 507, and an auxiliary memory 508.

The CPU 501 controls the entire operation of the MFP 10. The CPU 501 is connected to a chipset including the system memory 502, the NB 503, and the SB 504a, and is connected to other devices via the chipset.

The system memory 502 is for storing programs and data, loading programs and data, and storing drawing data of a printer. The system memory 502 includes a read only memory (ROM) and a random access memory (RAM). The ROM is for storing programs and data. The RAM is a writable and readable memory for loading programs and data, and storing drawing data of the printer.

The NB 503 is a bridge for connecting the CPU 501 to the system memory 502, the SB 504a, and an Accelerated Graphics Port (AGP) bus 505. The NB 503 includes a memory controller that controls reading from and writing to the system memory 502, a peripheral component interconnect (PCI) master, and an AGP target.

The SB 504a connects the NB 503 with PCI devices and peripheral devices. The SB 504a is connected to the NB 503 via the PCI bus 500P1. The network I/F 504b, the USB I/F 504c, and the Centronics I/F 504d are connected to the PCI bus 500P1.

The AGP bus 505 is a bus interface for graphics accelerator cards to accelerate graphics processing. The AGP bus 505 can speed up the graphics accelerator card by directly accessing the system memory 502 with high throughput.

The ASIC 506 is an integrated circuit (IC) for image processing applications having hardware elements for image processing. The ASIC 506 serves as a bridge that connects the AGP bus 505, the PCI bus 500P2, the auxiliary memory 508, and the local memory 507 with each other. The ASIC 506 includes a PCI target, an AGP master, an arbiter (ARB) as a central processor of the ASIC 506, a memory controller for controlling the local memory 507, a plurality of direct memory access controllers (DMACs) capable of rotating image data with a hardware logic, and a PCI unit that transfers data between the plotter 531 and the scanner 532 via the PCI bus 500P2. For example, the FCU 520, the plotter 531, the scanner 532, and the interface 533 are connected to the ASIC 506 via the PCI bus 500P2. The ASIC 506 is also connected to a host personal computer (PC) and a network.

The local memory 507 is used as a copy image buffer and a code buffer.

The auxiliary memory 508 is a storage area such as a hard disk drive (HDD), a solid state drive (SSD), a Secure Digital (SD) card, or flash memory, and stores image data, programs, font data, and forms.

The program designed for the MFP 10 may be recorded on a computer-readable recording medium, such as the auxiliary memory 508, for distribution in an installable or an executable file format.

The hardware configuration of the MFP 10 illustrated in FIG. 2 is an example. The MFP 10 may omit some of the components illustrated in FIG. 2 or include one or more components.

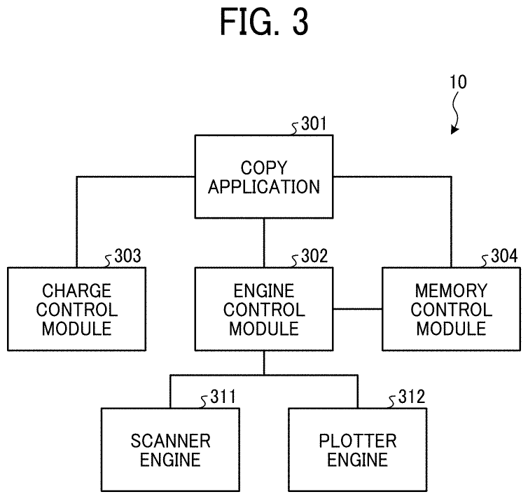

FIG. 3 is a block diagram illustrating an example of a software configuration of the MFP according to the present embodiment. The software configuration of the MFP 10 according to the present embodiment will be described with reference to FIG. 3.

As illustrated in FIG. 3, the MFP 10 includes, as software to be executed, a copy application 301, an engine control module 302, a charge control module 303, a memory control module 304, a scanner engine 311, and a plotter engine 312. The plotter engine 312 may be considered a printer engine, and includes any type of printer engine including a laser or LED based printer engine that uses toner, an inkjet printer engine, a thermal printer engine, or any other desired type of printer engine.

The copy application 301 is an application having a blank page removal function to be described later. The copy application 301 controls and manages copy jobs. The copy application 301 receives a copy job execution request based on a user operation on the control panel 510, and requests the engine control module 302 to perform copying.

The engine control module 302 is a software module that controls operation of the scanner engine 311 and the plotter engine 312 in accordance with a processing request from the copy application 301. The engine control module 302 controls the memory control module 304 to store an image (read image) read by the scanner 532 in the system memory 502 or the auxiliary memory 508, under the control of the scanner engine 311.

The charge control module 303 is a module that counts charges and executes charge processing in accordance with a request from the copy application 301.

The memory control module 304 is a module that executes reading and writing of data from and to the system memory 502 or the auxiliary memory 508 in accordance with a request from the copy application 301, the engine control module 302, or the like.

The scanner engine 311 is a module that controls the operation of the scanner 532 in accordance with an instruction from the engine control module 302.

The plotter engine 312 is a module that controls the operation of the plotter 531 in accordance with an instruction from the engine control module 302.

The software configuration of the MFP 10 is not limited to the configuration illustrated in FIG. 3, and may be any software configuration that implements the operation of the MFP 10.

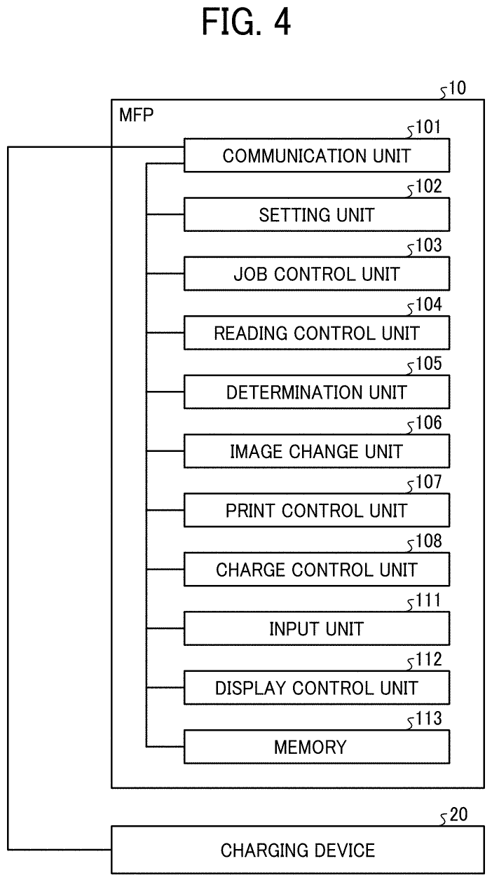

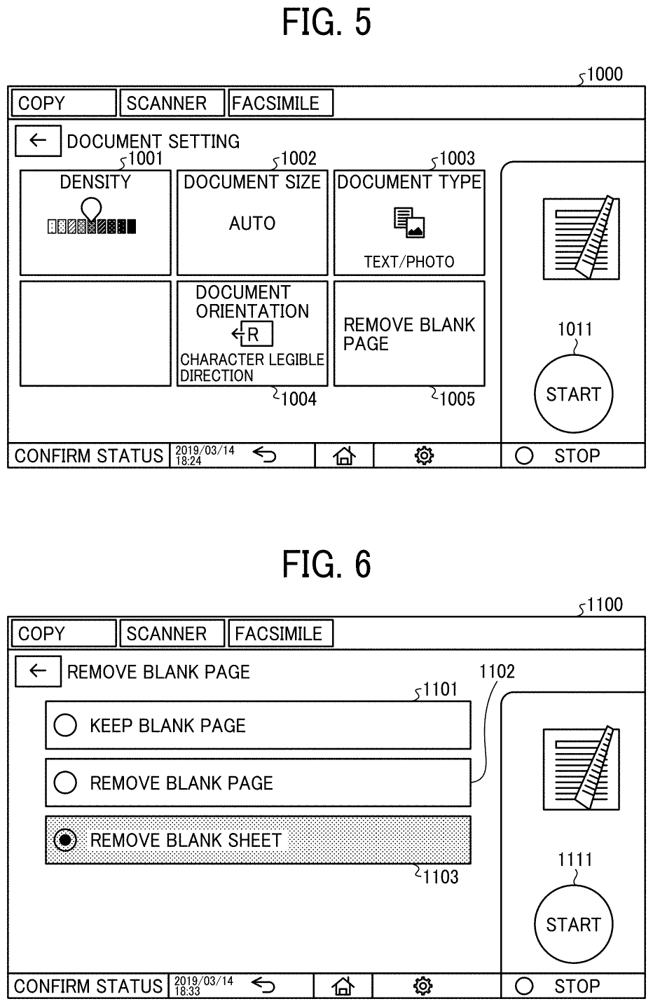

FIG. 4 is a block diagram illustrating an example of a functional configuration of the MFP according to the present embodiment. FIG. 5 is a view illustrating an example of a copy application screen according to the present embodiment. FIG. 6 is a view illustrating examples of a blank page removal setting screen. Descriptions are given below of the functional configuration and operation of the MFP 10 according to the present embodiment, with reference to FIGS. 4 to 6. The functional configuration is mainly implemented by the controller 500 of the MFP 10.

As illustrated in FIG. 4, the MFP 10 includes a communication unit 101, a setting unit 102, a job control unit 103, a reading control unit 104, a determination unit 105, an image change unit 106, a print control unit 107, a charge control unit 108, an input unit 111, a display control unit 112, and a memory 113.

The communication unit 101 is a functional unit for performing data communication with the charging device 20. The communication unit 101 is implemented, for example, by the interface 533 and the CPU 501 illustrated in FIG. 2 that execute a program. Instead of the interface 533, the network I/F 504b or the USB I/F 504c may be used.

The setting unit 102 is a processing unit that performs various setting items such as blank sheet removal and print settings according to an operation of the control panel 510 by the user. There are three types of blank page removal settings, namely, a first setting for removing a blank page, a second setting for removing a blank sheet, and a third setting for copying or printing a document as is without removing any blank page and any blank sheet. The term “blank page” refers to a page (image) recognized as a blank page (front side or back side) in the read image of the document. The term “blank sheet” refers to a sheet (or images corresponding to the sheet) whose front and back sides correspond to blank pages in a case where a read image including blank pages is printed as is (in single-sided printing or double-sided printing).

In some cases, it is unfeasible or undesirable to enable the above-described blank sheet removal function (the first setting or the second setting) in combination with a specific item of the print settings. For example, assume that book type (two-page spread) is specified as the document setting and double-sided printing is specified as output setting. In this case, it is difficult to determine whether a blank page included in the two-page spread document is intended by the user. It is not desirable to enable the above-described blank page removal function in combination with such print settings. Further, assume that poster printing is specified in the print settings. Poster printing is enlarging one page so as to be printed over a plurality of sheets. In this case, a blank page and a blank sheet should not be excluded. It is not desirable to enable the above-described blank sheet removal function in combination with the poster printing. In addition, in the print settings, the document setting may be a mixture of a single-sided document and a double-sided document. In this case, it is difficult to determine whether to remove a blank page in the document and whether to prevent a blank sheet arising in the print result. Accordingly, it is undesirable to enable the above-described blank sheet removal function in the case of a mixture of a single-sided document and a double-sided document. In addition, there may be a case where the two-page spread is specified as the document setting and combine printing is specified as an output setting. The combine printing is outputting the print result in a state of a booklet (like a magazine or a mini book). In this case, it is difficult to determine whether a blank page included in the two-page spread document is intended by the user. It is not desirable to enable the above-described blank page removal function in combination with such print settings. In the case where the user sets the above-described first setting or the second setting of blank sheet removal function in combination with such specific print settings, the setting unit 102 disables the blank page removal function. The display control unit 112 displays, on the control panel 510, a warning indicating that the blank page removal function is not available. The warning is, for example, a screen, a dialog box, or a message. The above-described specific print settings are examples. When another setting not to be combined with the blank page removal function is set, the blank page removal setting may be disabled, and a warning may be displayed in the same manner as described above.

The setting unit 102 stores, in the memory 113, the setting data (setting information). The setting unit 102 is implemented by the CPU 501 illustrated in FIG. 2 that executes a program (e.g., the copy application 301), for example.

The job control unit 103 is a processing unit that controls operations for copying based on the blank sheet removal function in accordance with a copy job. The job control unit 103 is implemented as the CPU 501 illustrated in FIG. 2 executes a program (the copy application 301), for example.

The reading control unit 104 is a functional unit that controls an operation of the scanner 532 for reading a document according to a reading instruction from the job control unit 103. The reading control unit 104 stores, in the memory 113, a read image (an example of print data) read by the scanner 532. The reading control unit 104 is implemented by, for example, the CPU 501 illustrated in FIG. 2 executing a program (the engine control module 302 and the scanner engine 311).

The determination unit 105 is a processing unit that determines whether the image of each page of the document, read by the reading control unit 104, is a blank page. The determination unit 105 is implemented by the CPU 501 illustrated in FIG. 2 executing a program (the copy application 301), for example.

The image change unit 106 is a processing unit that changes the image read by the reading control unit 104 based on the setting information of the blank page removal function set by the setting unit 102 and the determination result by the determination unit 105. For example, when the first setting of the blank page removal function is set, the image change unit 106 removes the blank page from the read image data, thereby changing the image configuration according to the set print settings, and generates changed print data having the changed image configuration. When the second setting of the blank page removal function is set, the image change unit 106 processes the read image data including blank pages as follows. The image change unit 106 removes a blank sheet that arises assuming that the read image is printed according to the set print settings. Then, the image change unit 106 generates changed print data according to the print settings. When the third setting of the blank sheet removal function is set, the image change unit 106 generates changed print data having the image configuration changed from the read image data according to the set print settings. The determination on the read image by the determination unit and changing of the read image data by the image change unit 106 may be performed either every time the reading control unit 104 reads one page of the document, or after all pages of the document are read. The image change unit 106 is implemented by the CPU 501 illustrated in FIG. 2 executing a program (the copy application 301), for example.

The print control unit 107 is a processing unit that controls the plotter 531 to perform printing, on one or more print media, according to the changed print data generated by the image change unit 106, in accordance with the set print settings. The print control unit 107 is implemented by, for example, the CPU 501 illustrated in FIG. 2 executing a program (the engine control module 302 and the plotter engine 312).

Based on the print result of the changed print data, the charge control unit 108 counts the print charges according to the number of pages of the output print sheets (the number of pages printed on the front sides and the back sides of the sheets). Then, the charge control unit 108 controls the charging device 20 to subtract the counted charges from the money put in the charging device 20 or from the inserted prepaid card or electronic money. In a case where the second setting of the blank sheet removal setting is set, since the images corresponding to the blank sheet is removed from the read image data, the charge control unit 108 does not count the print charges for the removed images. In addition, the charge control unit 108 does not count the print charges for the blank page in the print result (printed sheets) of the changed print data. The charge control unit 108 is implemented by the CPU 501 illustrated in FIG. 2 executing a program (the charge control module 303), for example.

The input unit 111 is a functional unit that receives an input operation performed by a user. The input unit 111 is implemented by the input function of the control panel 510 illustrated in FIG. 2.

The display control unit 112 is a functional unit that controls display of various screens such as an operation screen on the control panel 510. FIG. 5 illustrates a copy application screen 1000 that is a screen for performing various print settings, setting of the blank page removal function displayed on the control panel 510 under the control of the display control unit 112. As illustrated in FIG. 5, the copy application screen 1000 includes a density setting button 1001, a size setting button 1002, a type setting button 1003, a direction setting button 1004, a blank page removal button 1005, and a copy execution button 1011.

The density setting button 1001 is a button for setting the density of the image to be printed. The size setting button 1002 is a button for setting the size of the document to be copied. The type setting button 1003 is a button for setting the type of the document to be copied. The direction setting button 1004 is a button for setting the direction of the document to be copied, set on the MFP 10. The copy execution button 1011 is a button for executing copying according to the set print settings and the blank page removal setting.

The blank page removal button 1005 is a button for setting the blank page removal function. When the user presses the blank page removal button 1005, the display control unit 112 displays, on the control panel 510, a blank page removal setting screen 1100 illustrated in FIG. 6.

The blank page removal setting screen 1100 is a screen for selecting one of the first to the third settings of the blank sheet removal function. As illustrated in FIG. 6, the blank page removal setting screen 1100 includes a keep blank page button 1101, a remove blank page button 1102, a remove blank sheet button 1103, and a copy execution button 1111.

The keep blank page button 1101 is a button for selecting the third setting of the blank sheet removal function. The remove blank page button 1102 is a button for selecting the first setting of the blank page removal function. The remove blank sheet button 1103 is a button for selecting the second setting of the blank sheet removal function (blank images removed from read image are not counted for print charge). In response to selecting of any one of the keep blank page button 1101, the remove blank page button 1102, and the remove blank sheet button 1103 by the user, the setting unit 102 stores the setting of the blank page removal function corresponding to the selected button in the memory 113 as setting information.

The copy execution button 1111 is a button for executing copying according to the set print settings and the blank page removal setting.

The display control unit 112 is implemented by, for example, the CPU 501 illustrated in FIG. 2 executing a program.

The memory 113 stores a read image, changed print data, information of settings such as print settings and the blank sheet removal setting. The memory 113 is implemented by at least one of the system memory 502 and the auxiliary memory 508 illustrated in FIG. 2.

Of the functional units of the MFP 10 illustrated in FIG. 4, at least a part of the functional units implemented by software (program) may be implemented by a hardware circuit such as a field-programmable gate array (FPGA) or an application specific integrated circuit (ASIC).

Each functional unit of the MFP 10 illustrated in FIG. 4 is a conceptual representation of a function, and the functional configuration of the MFP 10 is not limited thereto. For example, a plurality of functional units of the MFP 10 illustrated as independent units in FIG. 4 may be integrated into a single functional unit. On the other hand, in the MFP 10 illustrated in FIG. 4, a single function may be divided into a plurality of functions, and a single functional unit may be divided into a plurality of functional units.

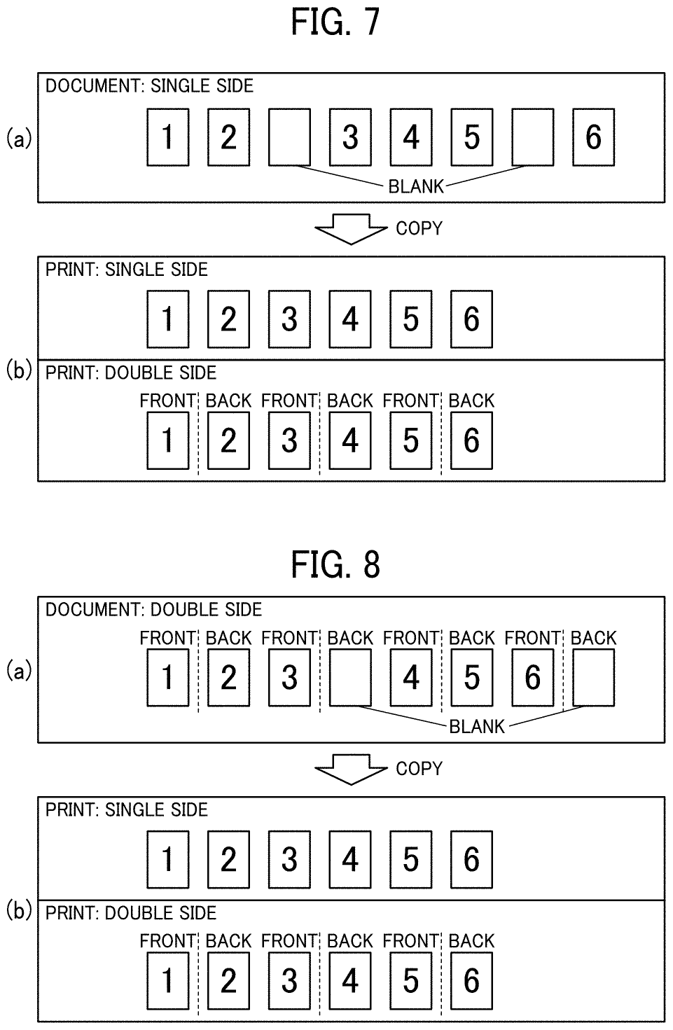

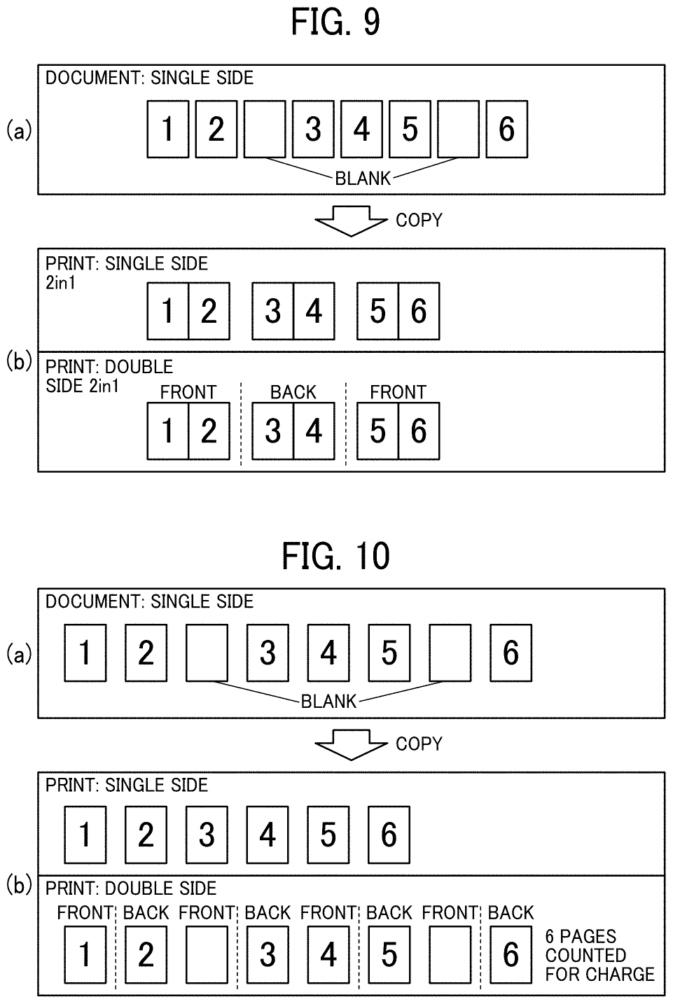

A description is given below of the blank page removal process. FIG. 7 is a diagram illustrating the operation of the blank page removal process for a single-sided document. FIG. 8 is a diagram illustrating the operation of the blank page removal process for a double-sided document. FIG. 9 is a diagram illustrating the operation of the blank page removal process in two-in-one combine printing. The blank page removal process based on the first setting of the blank page removal function will be described with reference to FIGS. 7 to 9.

In the example illustrated in FIG. 7, the document is a single-sided print matter, and single-sided printing or double-sided printing is performed in accordance with the first setting for removing any blank page. Section (a) of FIG. 7 illustrates a document including eight single-sided sheets, in which the third and seventh sheets are blank pages. To copy the single-sided document illustrated in section (a) of FIG. 7, first, the reading control unit 104 controls the scanner 532 to read one side of each single-sided document sheet, thereby obtaining read image data. Next, the determination unit 105 determines that images corresponding to the third and the seventh sheets of the read image data are blank pages. When the single-sided printing is set, as illustrated in section (b) of FIG. 7, the image change unit 106 removes images corresponding to the third and seventh blank sheets from the read image data, and generates changed print data for printing the images of the first, second, fourth to sixth, and eighth sheets of the read image data in single-sided printing. When the double-sided printing is set, as illustrated in section (b) of FIG. 7, the image change unit 106 removes the images corresponding to the third and seventh blank sheets from the read image data, and generates changed print data for printing the images of the first, second, fourth to sixth, and eighth sheets of the read image data in double-sided printing (open from right or left). In addition, regardless of whether single-sided printing or double-sided printing is set, since the number of pages on which images are printed is six pages, the charge control unit 108 counts the print charges for six pages.

In the example illustrated in FIG. 8, the document is a double-sided print matter, and single-sided printing or double-sided printing is performed in accordance with the first setting for removing any blank page. As illustrated in section (a) of FIG. 8, the double-sided document includes four sheets, and the back side of the second sheet and the back side of the fourth sheet are blank pages. To copy the double-sided document illustrated in section (a) of FIG. 8, first, the reading control unit 104 controls the scanner 532 to read both sides of each double-sided document sheet, thereby obtaining read image data. Next, the determination unit 105 determines that images corresponding to the back side of the second sheet and the back side of the fourth sheet in the read image data are blank pages. When the single-sided printing is set, as illustrated in section (b) of FIG. 8, the image change unit 106 removes the images corresponding to the back side of the second sheet and the back side of the fourth sheet, which are blank pages, from the read image data, and generates changed print data for printing the rest of the read image data in single-sided printing. When the double-sided printing is set, as illustrated in section (b) of FIG. 8, the image change unit 106 removes the images corresponding to the back side of the second sheet and the back side of the fourth sheet, which are blank pages, from the read image data, and generates changed print data for printing the rest of the read image data in double-sided printing (open from right or left). In addition, regardless of whether single-sided printing or double-sided printing is set, since the number of pages on which images are printed is six pages, the charge control unit 108 counts the print charges for six pages.

In the example illustrated in FIG. 9, the document is a single-sided print matter, and single-sided printing or double-sided printing is performed in two-in-one combine in accordance with the first setting for removing any blank page. The term “two-in-one combine” refers to printing images of two pages collectively printed on one page. Section (a) of FIG. 9 illustrates a document including eight single-sided sheets, in which the third and seventh sheets are blank pages. To copy the single-sided document illustrated in section (a) of FIG. 9, first, the reading control unit 104 controls the scanner 532 to read one side of each single-sided document sheet, thereby obtaining read image data. Next, the determination unit 105 determines that images corresponding to the third and the seventh sheets of the read image data are blank pages. When the two-in-one combine in single-sided printing is set, as illustrated in section (b) of FIG. 9, the image change unit 106 removes the images corresponding to the third and seventh blank sheets from the read image data, and generates changed print data for printing the images of the first, second, fourth to sixth, and eighth sheets of the read image data in the two-in-one combine in single-sided printing. When the two-in-one combine in double-sided printing is set, as illustrated in section (b) of FIG. 9, the image change unit 106 removes the images corresponding to the third and seventh blank sheets from the read image data, and generates changed print data for printing the images of the first, second, fourth to sixth, and eighth sheets of the read image data in the two-in-one combine in double-sided printing. In addition, regardless of whether the print setting is single-sided printing or double-sided printing, since the number of pages on which images are printed is three pages, the charge control unit 108 counts the charges for three pages.

The above-description referring to FIG. 9 concerns the case where the single-sided document is subjected to the two-in-one combine in single-sided printing and the double-sided printing. The same applies to the case where the double-sided document is subjected to the two-in-one combine in single-sided printing and double-sided printing.

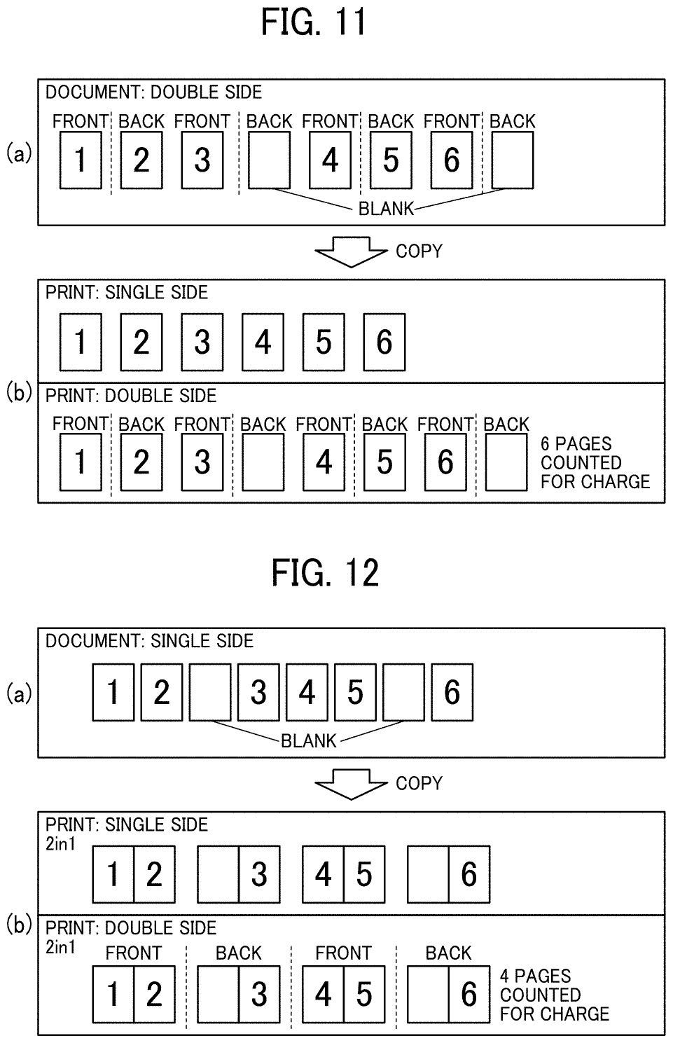

A description is given below of the blank sheet removal process. FIG. 10 is a diagram illustrating the operation of the blank sheet removal process for a single-sided document. FIG. 11 is a diagram illustrating the operation of the blank sheet removal process for a double-sided document. FIG. 12 is a diagram illustrating the operation of the blank sheet removal process in two-in-one combine printing. The blank sheet removal process based on the second setting of the blank sheet removal function will be described with reference to FIGS. 10 to 12.

In the example illustrated in FIG. 10, the document is a single-sided print matter, and single-sided printing or double-sided printing is performed in accordance with the second setting for removing any blank sheet. Section (a) of FIG. 10 illustrates a document including eight single-sided sheets, in which the third and seventh sheets are blank pages. To copy the single-sided document illustrated in section (a) of FIG. 10, first, the reading control unit 104 controls the scanner 532 to read one side of each single-sided document sheet, thereby obtaining read image data. Next, the determination unit 105 determines that images corresponding to the third and the seventh sheets of the read image data are blank pages. Assume that the type is single-sided printing. As illustrated in the upper part of section (b) of FIG. 10, the image change unit 106 removes, from the read image data including blank pages, the images corresponding to blank sheets that arise when the read image is printed in single-sided printing. Then, the image change unit 106 changes the image configuration reflecting the removal, according to the single-sided printing, and generates changed print data. By contrast, assume that the print type is double-sided printing. The image change unit 106 removes, from the read image data including blank pages, the images corresponding to a blank sheet that arises when the read image is printed in double-sided printing. Then, the image change unit 106 changes the image configuration reflecting the removal, according to the single-sided printing, and generates changed print data. However, as illustrated in the lower part of section (b) of FIG. 10, no blank sheet arises in this case. In the generated changed print data, the third blank page of the read image data remains on the front side of the second sheet, and the seventh blank page of the read image data remains on the front side of the fourth sheet. In addition, regardless of whether the print setting is single-sided printing or double-sided printing, the number of pages on which images are printed is six pages, and the blank pages are free of charge. Then, the charge control unit 108 counts the print charges for six pages.

In the example illustrated in FIG. 11, the document is a double-sided print matter, and single-sided printing or double-sided printing is performed in accordance with the second setting for removing any blank sheet. As illustrated in section (a) of FIG. 11, the double-sided document includes four sheets, and the back side of the second sheet and the back side of the fourth sheet are blank pages. To copy the double-sided document illustrated in section (a) of FIG. 11, first, the reading control unit 104 controls the scanner 532 to read both sides of each double-sided document sheet, thereby obtaining read image data. Next, the determination unit 105 determines that images corresponding to the back side of the second sheet and the back side of the fourth sheet in the read image data are blank pages. Assume that the print type is single-sided printing. As illustrated in section (b) of FIG. 11, the image change unit 106 removes, from the read image data including blank pages, the images corresponding to blank sheets that arise when the read image is printed in single-sided printing. Then, the image change unit 106 changes the image configuration reflecting the removal, according to the single-sided printing, and generates changed print data. By contrast, assume that the print type is double-sided printing. The image change unit 106 removes, from the read image data including blank pages, the images corresponding to a blank sheet that arises when the read image is printed in double-sided printing. Then, the image change unit 106 changes the image configuration reflecting the removal, according to the double-sided printing, and generates changed print data. However, as illustrated in section (b) of FIG. 11, no blank sheet arises in this case. In the generated changed image, the blank page on the back side of the second sheet of the read image data remains on the back side of the second sheet, and the blank page on the back side of the fourth page of the read image data remains on the back side of the fourth sheet. In addition, regardless of whether the print setting is single-sided printing or double-sided printing, the number of pages on which images are printed is six pages, and the blank pages are free of charge. Then, the charge control unit 108 counts the print charges for six pages.

In the example illustrated in FIG. 12, the document is a single-sided print matter, and the two-in-one combine in either single-sided printing or double-sided printing is performed in accordance with the second setting for removing any blank sheet. Section (a) of FIG. 12 illustrates a document including eight single-sided sheets, in which the third and seventh sheets are blank pages. To copy the single-sided document illustrated in section (a) of FIG. 12, first, the reading control unit 104 controls the scanner 532 to read one side of each single-sided document sheet, thereby obtaining read image data. Next, the determination unit 105 determines that images corresponding to the third and the seventh sheets of the read image data are blank pages. Assume that the two-in-one combine in single-sided printing is set. The image change unit 106 removes, from the read image data including blank pages, the images corresponding to blank sheets that arise when the read image is printed in the two-in-one combine in single-sided printing. Then, the image change unit 106 changes the image configuration reflecting the removal, according to the two-in-one combine in single-sided printing, and generates changed print data. However, as illustrated in the upper part of section (b) of FIG. 12, no blank sheet arises in this case. In the generated changed image, the third blank page of the read image data remains on the second sheet, and the seventh blank page of the read image data remains on the fourth sheet. By contrast, assume that the two-in-one combine in double-sided printing is set. The image change unit 106 removes, from the read image data including blank pages, the images corresponding to a blank sheet that arises when the read image is printed in the two-in-one combine in double-sided printing. Then, the image change unit 106 changes the image configuration reflecting the removal, according to the two-in-one combine in double-sided printing, and generates changed print data. However, as illustrated in the lower part of section (b) of FIG. 12, no blank sheet arises in this case. In the generated changed image, the third blank page of the read image data remains on the back side of the first sheet, and the seventh blank page of the read image data remains on the back side of the second sheet. In addition, regardless of whether the print setting is single-sided printing or double-sided printing, since the number of pages on which images are printed is four pages, the charge control unit 108 counts the charges for four pages.

The above-description referring to FIG. 12 concerns the case where the single-sided document is subjected to the two-in-one combine in single-sided printing and the double-sided printing. The same applies to the case where the double-sided document is subjected to the two-in-one combine in single-sided printing and double-sided printing.

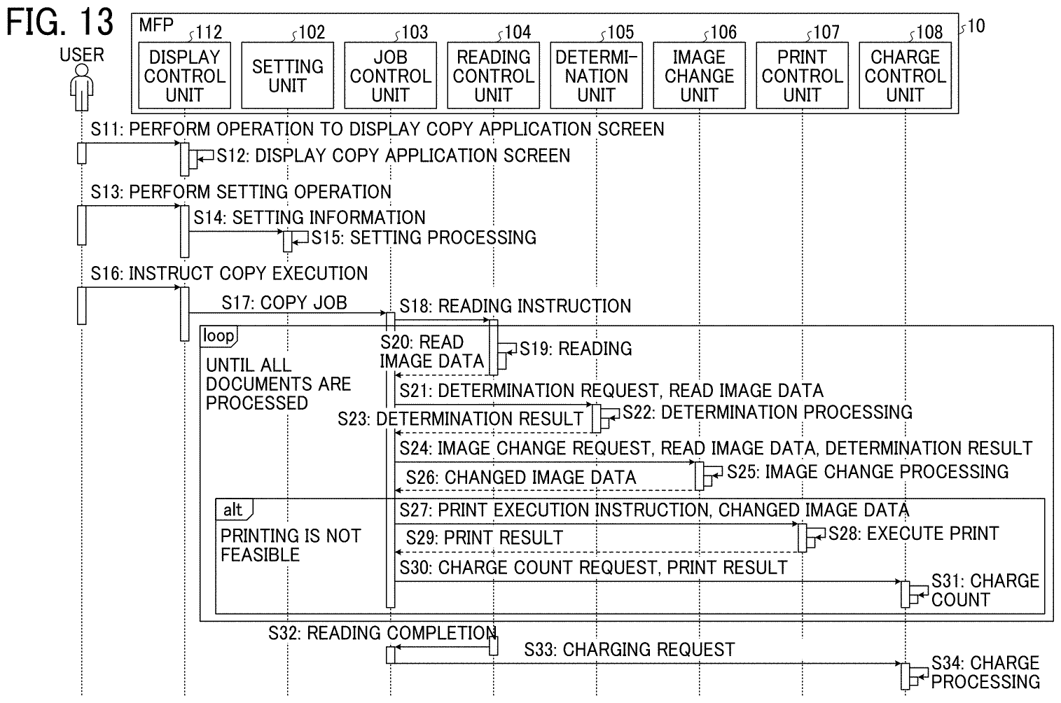

FIG. 13 is a flowchart illustrating an example of the copying process performed by the MFP according to the present embodiment. A description is given below of a copying process performed by the MFP 10 according the present embodiment, with reference to FIG. 13.

Steps S11 and S12

The user sets a document on the ADF of the MFP 10 and performs, on the input unit 111, an operation to display the copy application screen 1000. Then, the display control unit 112 displays the copy application screen 1000 on the control panel 510.

Steps S13 and S14

In response to setting operation by the user, that is, pressing the blank page removal button 1005 on the copy application screen 1000, the display control unit 112 displays, on the control panel 510, the blank page removal setting screen 1100. Then, the user operates one of the keep blank page button 1101, the remove blank page button 1102, and the remove blank sheet button 1103, thereby selecting one of the first to third settings of the blank page removal function. The display control unit 112 sends the content (setting information) corresponding to the selecting operation by the user to the setting unit 102.

Step S15

The setting unit 102 stores one of the first to third settings selected by the user as setting information in the memory 113.

Step S16

In response to the copy execution instruction (pressing of the copy execution button 1111 on the blank page removal setting screen 1100) by the user, the MFP 10 starts the copying process.

Steps S17 and 18

In response to the start of the copying process, first, the display control unit 112 sends a copy job for a document set on the ADF to the job control unit 103. In response to receiving the copy job, the job control unit 103 sends a reading instruction for reading the document to the reading control unit 104.

Steps S19 and S20

The reading control unit 104 causes the scanner 532 to read the document according to the reading instruction. In the case where the double-sided document is set as the print setting, the reading control unit 104 causes the scanner 532 to read both the front side and the back side of each document sheet. The reading control unit 104 acquires a read image every time an image of one page of the document is read. Then, the reading control unit 104 sends the acquired read image to the job control unit 103.

Step S21

In response to receiving the read image, the job control unit 103 sends a determination request for determining whether the read image is a blank page to the determination unit 105 together with the read image.

Steps S22 and S23

In response to receiving the read image and the determination request, the determination unit 105 determines whether the read image is a blank page. Then, the determination unit 105 returns the determination result to the job control unit 103.

Step S24

In response to receiving the determination result from the determination unit 105, the job control unit 103 sends the read image and an image change request for the read image to the image change unit 106 together with the determination result.

Steps S25 and S26

In response to receiving the determination result, the read image, and the image change request, the image change unit 106 retrieves the print settings and the setting information of the blank page removal function from the memory 113.

When the first setting for removing blank pages is set, the image change unit 106 removes blank pages from the read image data, change the image configuration according to the print settings, and generates changed print data. The specific operation is as described above with reference to FIGS. 7 to 9.

When the second setting for removing blank sheets is set, the image change unit 106 determines whether a blank sheet is to be generated by printing of the read image (print data) in accordance with the print settings. The image change unit 106 removes, from the read image data, one or more blank pages to avoid generation of the blank sheet. Then, the image change unit 106 generates changed print data having the image configuration reflecting the removal, according to the print settings. The specific operation is as described above with reference to FIGS. 10 to 12.

Note that the image changing performed by the image change unit 106 conceptually includes operation of removing the read image corresponding to one page determined as being a blank page in the first setting and removing the read image corresponding to one sheet determined as being a blank sheet. The changed print data generated by the image changing conceptually includes data in which the read image of one page is removed due to the above-described result.

When the third setting for keeping any blank page is set, the image change unit 106 generates changed print data having the image configuration changed according to the set print settings. In this case, regardless of the determination result by the determination unit 105, the changed print data includes the image of the blank page as is.

Then, the image change unit 106 returns the generated changed print data to the job control unit 103.

Steps S27 through S29

In response to receiving the changed print data, the job control unit 103 sends a print execution instruction together with the changed print data to the print control unit 107. In response to receiving the changed print data and the print execution instruction, the print control unit 107 causes the plotter 531 to execute printing according to the changed print data, in accordance with the set print settings. Then, the print control unit 107 returns the print result thereof to the job control unit 103.

Steps S30 and S31

In response to receiving the print result, the job control unit 103 sends a charge count request together with the print result to the charge control unit 108. In response to receiving the print result and the charge count request, the charge control unit 108 counts the charges for the print result. In a case where the second setting of the blank sheet removal is set, since the image corresponding to the blank sheet is removed from the read image data, the charge control unit 108 does not count the charges for the removed image (excludes the removed image from charge count). In addition, the charge control unit 108 does not count the charge for the blank page in the print result of the changed print data (excludes the blank page from the charge count).

The processing in steps S19 to S31 described above is executed until all the document sheets on the ADF are processed.

Step S32

After all the document sheets on the ADF are processed in steps S19 to S31, the reading control unit 104 returns a reading completion notification to the job control unit 103.

Steps S33 and S34

In response to receiving the reading completion notification, the job control unit 103 sends a request for executing charging (charging request) to the charge control unit 108. In response to receiving the charging request, the charge control unit 108 causes the charging device 20 to subtract the amount corresponding to the charges from the money, the prepaid card, or electronic money put in the charging device 20 (charging processing). Thus, the MFP 10 ends the copying process.

As described above, in the MFP 10 according to the present embodiment, the determination unit 105 determines whether the page is blank for each page of the read image data, obtained by the reading control unit 104, to be printed. In response to determining that the read image data includes a blank page and printing of the read image data according to the print settings generates a blank sheet having front and back sides that are blank, the image change unit 106 removes the blank page from the read image data according to the setting of the blank sheet removal function. Then, the image change unit 106 generates changed print data having the image configuration according to the print settings. The print control unit 107 controls the plotter 531 to print the changed print data on the print media in accordance with the print settings. The charge control unit 108 excludes, from the charge count, the images corresponding to the blank sheet removed from the read image data. Further, the charge control unit 108 excludes, from the charge count, the blank page in the print result of the changed print data according to the print settings. With this configuration, the blank page removal function does not charge a fee for a blank page intentionally held by the user. In the first setting and the second setting of the blank page removal function, a blank sheet having a blank front side and a blank back side is removed, and the user is not charged for blank images in the read image data that correspond to the blank sheet.

In FIGS. 9 to 13, read image data is obtained by the scanner 532, and changed print data is obtained by changing of the read image data by the image change unit 106, but embodiments of the present disclosure are not limited thereto. For example, instead of the image data read by the scanner 532, the determination unit 105 may determine whether or not a page of image data or document data obtained in a different manner (e.g., obtained from an external device) is a blank page, and image data changed by the image change unit 106 may be printed. In this case, aspects of the present disclosure are applicable not only to an MFP but also to an image forming apparatus such as an inkjet printer or a laser printer having only a printer function.

Instead of the image change unit 106, the determination unit 105 may determine whether a blank sheet is to be generated by printing of the read image (print data) in accordance with the print settings.

In addition, although the charging is performed relative to the money, a prepaid card, electronic money, or the like put in the charging device 20, the manner of settlement of charges is not limited thereto. For example, a charging server may be used instead of the charging device 20, and settlement of copy fees or print fees may be made relative to, for example, credit card information or account information associated with the user information of the user of the MFP or the printer based on the charge count information.

Note that, in a case where at least a portion of the functional units of the MFP 10 according to the above-described embodiment is implemented by execution of a computer program, the program can be prestored in a ROM or the like. Alternatively, the computer program executed in the MFP 10 according the above-described embodiment can be provided as a file in an installable format or an executable format and stored in a computer-readable recording medium, such as a compact disc read only memory (CD-ROM), a flexible disk (FD), a compact disc recordable (CD-R), and a digital versatile disk (DVD). Further, the program executed by the MFP 10 according to the above-described embodiment may be stored on a computer connected to a network such as the Internet, to be downloaded via the network. Further, the computer program executed in the MFP 10 according the above-described embodiment may be provided or distributed via a network such as the Internet. A program to be executed by the MFP 10 according to the above-described embodiment has module structure including at least one of the above-described functional units. Regarding the actual hardware related to the program, the CPU 501 reads and executes the program from the memory (e.g., the system memory 502 or the auxiliary memory 508) to load the program onto the main memory to implement the above-described functional units.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An image forming apparatus comprising:
a printing engine configured to perform printing on print media; and
circuitry configured to:
determine whether each page of print data is a blank page;
determine whether a blank sheet is to be generated by printing of the print data in accordance with print settings;
determine whether to remove a blank page from the print data to avoid generation of the blank sheet;
generate changed print data based on whether to remove the blank page in accordance with the print settings;
control the printing engine to perform printing on the print media according to the changed print data in accordance with the print settings; and
count a number of pages printed, excluding blank pages in the printed pages and the blank page which have been removed from the print data.

2. The image forming apparatus according to claim 1, wherein the blank sheet has a front side and a back side that are blank.

3. The image forming apparatus according to claim 1,
wherein the circuitry controls a scanner to read a document to acquire the print data.

4. The image forming apparatus according to claim 1,
wherein the circuitry determines, based on an operation to an input device, whether to remove the blank page from the print data.

5. The image forming apparatus according to claim 4,
wherein the circuitry selects, based on the operation to the input device, either a first setting or a second setting, the first setting for removing blank pages from the print data, the second setting for removing the blank page to avoid generation of the blank sheet from the print data and keeping a blank page not to generate a blank sheet.

6. The image forming apparatus according to claim 5,
wherein the circuitry selects, based on the operation to the input device, either one of:
the first setting;
the second setting; and
a third setting for keeping blank pages in the print data and generating the changed print data in accordance with the print settings.

7. The image forming apparatus according to claim 5,
wherein the circuitry disables the first setting and the second setting depending on a specific print setting.

8. The image forming apparatus according to claim 5,
wherein the circuitry displays, on a display, a warning indicating that the first setting or the second setting is not selectable in response to an operation to the input device for setting the first setting or the second setting in addition to a specific print setting.

9. The image forming apparatus according to claim 1,
wherein the circuitry counts the printed pages based on a result of printing on the printing media according to the changed print data.

10. A method for forming an image, the method comprising:
determining whether each page of print data is a blank page;
determining whether a blank sheet is to be generated by printing of the print data in accordance with print settings;
determining whether to remove a blank page from the print data to avoid generation of the blank sheet;
generating changed print data based on whether to remove the blank page in accordance with the print settings;
controlling a printing engine to perform printing on print media according to the changed print data in accordance with the print settings; and
counting a number of pages printed, excluding blank pages in the printed pages and the blank page which have been removed from the print data.

11. A non-transitory recording medium storing a plurality of program codes which, when executed by one or more processors, causes the processors to perform a method, the method comprising:
determining whether each page of print data is a blank page;
determining whether a blank sheet is to be generated by printing of the print data in accordance with print settings;
determining whether to remove a blank page from the print data to avoid generation of the blank sheet;
generating changed print data based on whether to remove the blank page in accordance with the print settings;
controlling a printing engine to perform printing on print media according to the changed print data in accordance with the print settings; and
counting a number of pages printed, excluding blank pages in the printed pages and the blank page which have been removed from the print data.
